(19) United States
(12) Patent Application Publication
(10) Pub. No.: US 2015/0338538 A1
(43) Pub. Date: Nov. 26, 2015

(54) MULTI-MODEL SEISMIC PROCESSING OPERATION

(71) Applicant: WESTERNGECO L.L.C., Houston, TX (US)

(72) Inventors: Kuang-Hung Liu, Houston, TX (US); Clement Kostov, Houston, TX (US)

(73) Assignee: WESTERNGECO L.L.C., Houston, TX (US)

(21) Appl. No.: 14/283,839

(22) Filed: May 21, 2014

(51) Int. Cl. G01V 1/36; G01V 1/28

(52) U.S. Cl. CPC G01V 1/364; G01V 1/282

(57) ABSTRACT

Systems and methods for seismic processing are provided. For example, the method may include modeling seismic data as a combination of a modeling matrix and a parameter vector, and determining a plurality of solution spaces of filter models for the parameter vector. The method may also include calculating data residual terms for the filter models, wherein the data residual terms are related to a difference between the seismic data and a combination of the modeling matrix and the parameter vector determined using the filter models. The method may further include selecting a solution filter model for the parameter vector from among the filter models based on a combination of the data residual terms and complexities of the filter models, and performing a seismic processing operation using the solution filter model and the seismic data.

### BACKGROUND

In a variety of seismic processing operations, a linear equation can be developed for modeling a data set as a combination of a modeling matrix and a parameter vector. For example, in the case of adaptive subtraction, a seismic trace may include, among other things, a primary reflections signal and a multiple reflections (“multiples”) signal. The combination of the modeling matrix and the parameter vector models the multiples signal, and the model of the multiples signal can then be used to provide a finite impulse response filter. The finite impulse response filter can be applied to the seismic trace in order to subtract the multiples signal from the seismic trace.

Given the modeling matrix, the parameter vector may have several solutions, which may depend, for example, on the order of the parameter vector, i.e., the number of coefficients or “length” of the filter. Greater filter lengths in adaptive subtraction processes generally result in more aggressive tilt attenuate the residual multiples signal in the seismic trace to a greater extent, but may also alter the primary reflections signal or otherwise alter the seismic trace apart from the multiples signal. On the other hand, filters with smaller filter lengths may avoid removal of the primary reflections signal, but may attenuate the residual multiples signal to a lesser extent.

The filter length is thus generally provided as an input to the system. In practice, setting the filter length is generally an iterative process, in which a user guesses at a suitable filter length, applies the filter, and then judges the results, e.g., to determine the extent to which the multiple reflection signal is removed from the seismic trace versus any noted loss of the primary signal. In other words, trial-and-error is employed, and the selection of the filter length is based on a subjective estimation of the results. Thus, varying, the filter length across the survey may be difficult and time-consuming using, current procedures.

Accordingly, there is a need to loosen the requirement for an a priori known order for the parameter vector, thereby assisting with the selection of an optimal solution to the linear equation.

### SUMMARY

The above deficiencies and other problems associated with processing of collected data are reduced or eliminated by the disclosed methods and systems.

Embodiments of the disclosure may provide a method for processing seismic data. The method may include modeling seismic data as a combination of a modeling matrix and a parameter vector, and determining a plurality of solution spaces of filter models for the parameter vector. The method may also include calculating data residual terms for the filter models, wherein the respective data residual terms are related to a difference between the seismic data and a combination of the modeling matrix and the parameter vector determined using the respective filter models. The method may further include selecting a solution filter model for the parameter vector from among the filter models based on a combination of the data residual terms and complexities of the filter models, and performing a seismic processing operation using the solution filter model and the seismic data.

In an embodiment, the plurality of solution spaces are associated with a plurality of different complexities for the filter models.

In an embodiment, selecting the solution filter model includes determining respective smallest data residual terms using respective filter models in respective solution spaces in the plurality of solution spaces, and penalizing the filter models based on complexity.

In an embodiment, selecting the solution filter model includes applying a genera zed information criterion.

In an embodiment, calculating, the data residual terms includes calculating a norm of a difference between the seismic data and the modeling matrix multiplied by the parameter vector calculated using one of the filter models.

In an embodiment, the method also includes receiving a seismic trace, and partitioning the seismic trace into a plurality of windows of seismic data. Further, selecting the solution filter model for the parameter vector includes selecting respective filter models for respective windows in the plurality of windows. The respective filter models are based on the respective seismic data of the respective windows.

In an Embodiment, Performing the Seismic Processing Operation Includes Performing the seismic processing operation using the seismic data of the respective windows in combination with the respective filter models.

In an embodiment, wherein performing the seismic processing, operation includes performing an operation selected from the group consisting of residual moveout correction, amplitude versus offset analysis, adaptive filtering for multiples subtraction, predictive deconvolution, source-signature deconvolution and surface-consistent decomposition.

Embodiments of the disclosure may also provide a method for removing a signal element from a seismic trace. The method may include receiving the seismic trace, and determining one or more signal predictions for the seismic trace. The method may also include defining a plurality of sampling windows along the seismic trace, and selecting respective filter models for respective windows in the plurality of sampling windows based at least partially on a complexity of the respective filter models. The method may further include subtracting at least some of the signal element from the seismic trace in the respective sampling windows using the one or more signal predictions and the respective filter models that are selected.

In an embodiment, selecting the respective filter models includes selecting the respective filter models based additionally on a performance an adaptive subtraction process that uses the respective filter models on the seismic trace in the respective sampling windows.

In an embodiment, selecting the respective filter models includes calculating respective data fitting terms for the respective filter models, wherein the respective data fitting terms are related to residuals of the signal element left after subtracting a combination of the one or more signal predictions and the respective filter model from the seismic trace in the respective sampling windows.

In an embodiment, selecting the respective filter models includes selecting respective candidate filter models from respective solution spaces in a plurality of solution spaces based on a performance of an adaptive subtraction process using the respective candidate filter models relative to the performance of the adaptive subtraction process using other filter models of the respective solution spaces, and penalizing the selected candidate filter models based on a complexity of the selected candidate filter models.

In an embodiment, selecting the respective filter models includes selecting respective candidate filter models from respective solution spaces in plurality of solution spaces based on a performance of an adaptive subtraction process using the respective candidate filter models relative to an adaptive subtraction process using other filter models of the respective solution spaces, and determining a threshold based on a false alarm rate, wherein the threshold is related to a residuals tolerance of the signal element in the seismic trace. Selecting the respective filter models may also include determining test statistics for at least some of the candidate filter models, and selecting at least one of the candidate filter models associated with a test statistic that is less than the threshold.

In an embodiment, the method further includes receiving the false alarm rate from a user.

In an embodiment, determining the test statistics includes using a generalized likelihood ratio.

In an embodiment, for a first one of the sampling windows, the filter model that is selected has a first complexity, and for a second one of the one or more sampling windows, the filter model that is selected has a second complexity, the first and second complexities being different.

Embodiments of the disclosure may also provide a computing, system including one or more processors, and a memory system including one or more computer-readable media storing instructions thereon that, when executed by the one or more processors, are configured to cause the computing system to perform operations. The operations may include modeling seismic data as a combination of a modeling matrix and a parameter vector, and determining a plurality of solution spaces of filter models for the parameter vector. The operations may also include calculating data residual terms for the filter models, wherein the respective data residual terms are related to a difference between the seismic data and a combination of the modeling matrix and the parameter vector determined using the respective filter models. The operations may further include selecting a solution filter model for the parameter vector from among the filter models based on a combination of the data residual terms and complexities of the filter models, and performing a seismic processing operation using the solution filter model and the seismic data.

Embodiments of the disclosure may also provide a computing system including one or more processors, and a memory system including one or more computer-readable media storing instructions thereon that, when executed by the one or more processors, are configured to cause the computing system to perform operations. The operations may include receiving the seismic trace, and determining one or more signal predictions for the seismic trace. The method may also include defining a plurality of sampling windows along the seismic trace, and selecting respective filter models for respective windows in the plurality of sampling, windows based at least partially on a complexity of the respective filter models. The method may further include subtracting at least some of the signal element from the seismic trace in the respective sampling windows using the one or more signal predictions and the respective filter models that are selected.

In accordance with some embodiments, a computer-readable storage medium is provided, the medium having a set of one or more programs including instructions that when executed by a computing system cause the computing system to model seismic data as a combination of a modeling matrix and a parameter vector, and determine a plurality of solution spaces of filter models for the parameter vector. The instructions may also cause the computing system to calculate data residual terms for the filter models, wherein the respective data residual terms are related to a difference between the seismic data and a combination of the modeling matrix and the parameter vector determined using the respective filter models. The instructions may also cause the computing system to select a solution filter model for the parameter vector from among the filter models based on a combination of the data residual terms and complexities of the filter models, and perform a seismic processing operation using the solution filter model and the seismic data.

In accordance with some embodiments, a computer-readable storage medium is provided, the medium having a set of one or more programs including, instructions that when executed by a computing system cause the computing system to receive the seismic trace, and determine one or more signal predictions for the seismic trace. The instructions may also cause the computing system to define a plurality of sampling windows along the seismic trace, and select respective filter models for respective windows in the plurality of sampling windows based at least partially on a complexity of the respective filter models. The instructions may further cause the computing, system to subtract at least some of the signal element from the seismic trace in the respective sampling windows using the one or more signal predictions and the respective filter models that are selected.

In accordance with some embodiments, a computing system is provided that includes at least one processor, at least one memory, and one or more programs stored in the at least one memory. The computing system further includes means for modeling seismic data as a combination of a modeling matrix and a parameter vector, and means for determining a plurality of solution spaces of filter models for the parameter vector. The computing system may also include means for calculating data residual terms for the filter models, wherein the respective data residual terms are related to a difference between the seismic data and a combination of the modeling matrix and the parameter vector determined using the respective filter models. The computing system may further include means for selecting a solution filter model for the parameter vector from among the filter models based on a combination of the data residual terms and complexities of the filter models, and means for performing a seismic processing operation using the solution filter model and the seismic data.

In accordance with some embodiments, a computing system is provided that includes at least one processor, at least one memory, and one or more programs stored in the at least one memory. The computing system further includes means for receiving the seismic trace, and determining one or more signal predictions for the seismic trace. The computing system may also include means for defining a plurality of sampling windows along the seismic trace, and means for selecting respective filter models for respective windows in the plurality of sampling windows based at least partially on a complexity of the respective filter models. The computing system may further include means for subtracting at least some of the signal element from the seismic trace in the respective sampling windows using the one or more signal predictions and the respective filter models that are selected.

Thus, the computing systems and methods disclosed herein are more effective methods for processing collected data that may, for example, correspond to a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings, in the figures:

FIGS. 1 and 2 illustrate flowcharts of methods for processing collected data, according to an embodiment.

FIGS. 3A and 3B illustrate a domain of seismic data, before and alley an adaptive subtraction process is applied, respectively, according to an embodiment.

FIG. 4 illustrates a flowchart of a method for removing a signal element from a seismic trace, according to an embodiment.

FIGS. 5-7 illustrate flowcharts of methods for selecting a filter model, according to an embodiment.

FIGS. 8A and 8B illustrate a flowchart of a method for seismic processing, according to an embodiment.

FIGS. 9A and 9B illustrate a flowchart of a method for removing a signal element from a seismic trace, according to an embodiment.

FIG. 10 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

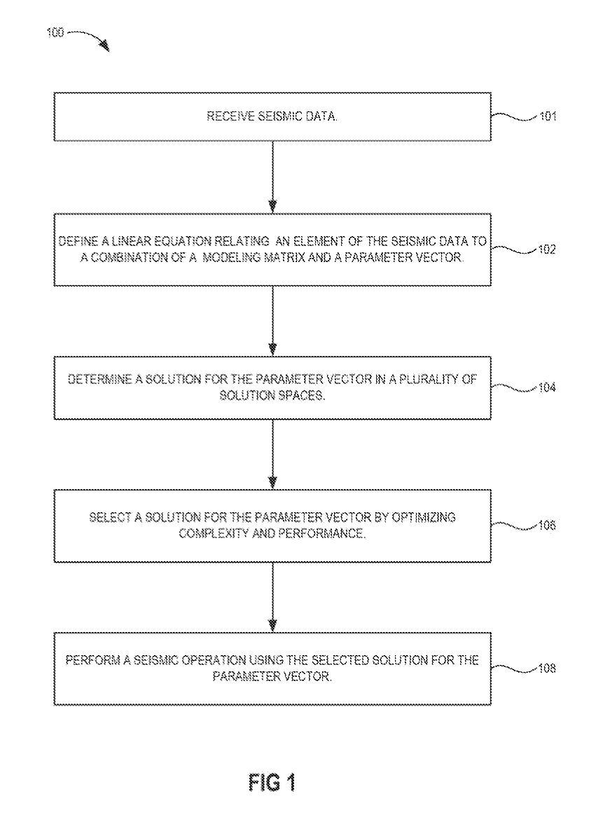

FIG. 1 illustrates a method 100 for processing collected data, according to an embodiment. In at least one example, the method 100 may be configured to provide a locally optimal filter based on data fitting and complexity of the filter, as will be described in greater detail below, hr particular, the method 100 may include receiving collected data, as at 101. The data may be, for example as illustrated in FIG. 1, seismic data, such as one or more seismic traces. The data may be collected in any manner, for example, using a seismic source and geophones, etc. The data collected may be recorded and provided on the fly, in batches, or after collection to one or more processors at 101. In other embodiments, any other type of data may be received, with it being appreciated that seismic data is but one example among many contemplated.

The method 100 may also include defining a linear equation relating an element of the collected data with a combination of a modeling, matrix and a parameter vector, as at 102. The linear equation may include other elements as well. Moreover, in some embodiments, the modeling matrix may be predetermined, for example, as part of a preselected seismic operation. In other embodiments, the modeling matrix may be calculated as part of the method 100.

The method 100 may also include determining a solution for the parameter vector in a plurality of solution spaces, as at 104, in some embodiments, each solution space may be associated with a complexity. The complexity is described herein in terms of length or order of the parameter vector. Those with skill in the an will appreciate, however, that in some embodiments, complexity could additionally or instead include the number of non-zero (or larger than a predetermined threshold) coefficients. Furthermore, in some applications, the complexity may be at least partially dependent upon the location of the windowed data (e.g., spatial information). Moreover, other measures of complexity are contemplated, including sparseness (e.g., as measured with an L₁ norm) and entropy of the parameter vector, among other possibilities. For example, each solution space may have a unique complexity, as compared with the complexities of the other solution spaces, and multiple possible models for the parameter vector may reside in each solution space. The available solution spaces may be predetermined, e.g., limited, for example, by imposing a range of acceptable complexities.

The method 100 may also include selecting a solution for the parameter vector by optimizing (or in some embodiments, complexity and/or performance thereof as applied to the collected data, as at 106. For example, the solution for the parameter vector ma be determined as the least complex parameter vector that results in adequate performance. Adequate performance may be measured by a fit of the combination of the modeling matrix and the parameter vector to the element of the collected data. Further, adequate performance may be relative to other potential solutions for the parameter vector, or may be relative to one or more application or user-defined metrics. In an embodiment, the selection at 106 may be configured to optimize (or enhance) a combination of complexity and fit, for example, by favoring lower-complexity models over higher-complexity models.

With the model selected, the parameter vector may be determined, using the selected model, and combined (e.g., multiplied) with the modeling matrix according to the linear equation developed at 102. The combination of the modeling matrix and the selected parameter vector may then be used to perform an operation, as at 108, in some embodiments, the operation is a seismic operation. In some embodiments, performing the operation may occur contemporaneously with the selection at 106, since, e.g., the selection may be based at least partially on the performance of the parameter vector in the seismic operation at 108. Accordingly, it will be appreciated that blocks 106 and 108 may occur at the same time, but in other cases, the parameter vector may be selected first, and then the operation conducted.

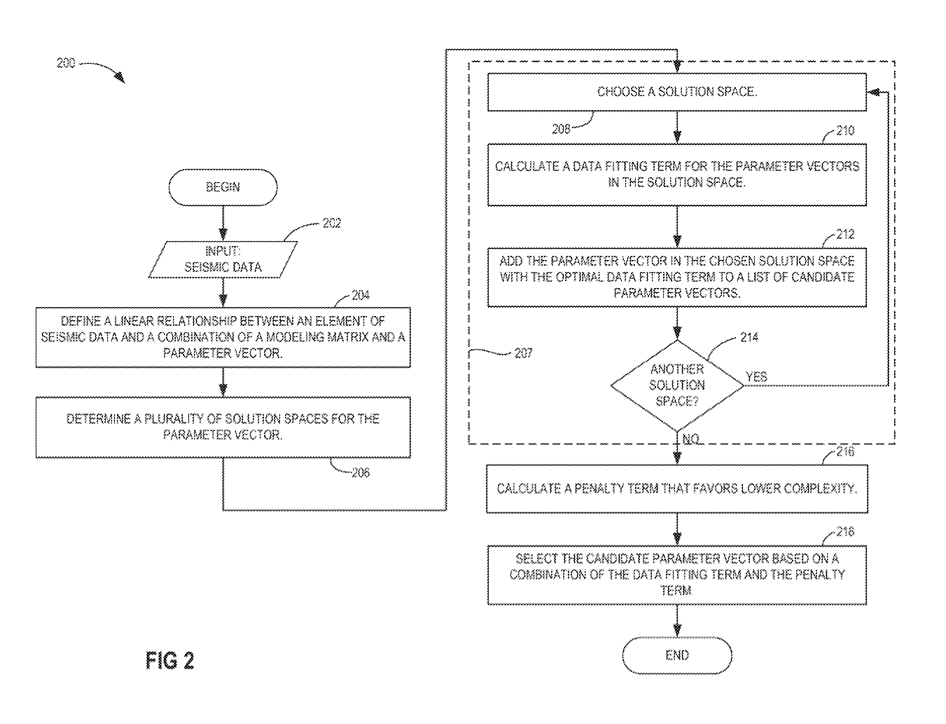

FIG. 2 illustrates a flowchart of another method 200 for processing collected data, according to an embodiment. As shown in FIG. 2, the collected data may, in some embodiments, be seismic data. The method 200 may receive, as an input, the collected data, as at 202. In an embodiment, the collected data received at 202 may be or include one or more seismic traces, e.g., similar to the seismic data received in method 100 at 101. The method 200 may also include defining a linear relationship between an element of the collected data and a combination of a modeling matrix and a parameter vector, as at 204. For example, the linear relationship may be:

d=Mp (1)

where d is a N-element vector representing the collected (e.g., seismic) data. M is an N×K modeling matrix representing a model of the collected data d, and p is a parameter vector of K-element vector order that specifies coefficients and resides in a solution space SᵢεS={S₁, S₂, . . . Sₙ}. The set of solution spaces S may be determined, as at 208. For example, a solution space Si in which a parameter vector p resides may be determined based on a complexity of the parameter vector p; that is, the number of elements K of the vector, for example. Further, the set of solution spaces S available may be determined based on a range of available complexities that is preset, predetermined, taken as input during the operation of the method 200, and/or determined in any other manner.

The method 200 may then proceed to a loop 207, iterating across one or more of the solution spaces Sᵢ in the set of solution spaces S. As such, in an embodiment, the method 200 may include choosing a solution space Sᵢ, as at 208, which may serve as the loop control variable. Considering this solution space Sᵢ, the method 200 may proceed to calculating residuals left after subtracting a combination of the modeling matrix M and the parameter vector p in the chosen solution space Sᵢ from the element of the seismic data d. This may be referred to as calculating a data fitting term for the parameter vectors in the solution space Sᵢ, as at 210.

In an example, the data fitting term may be related to a difference between the collected data d and the combination of the modeling matrix M and the parameter vector p, i.e., the “residuals” of the element of the data d left after removing the combination of the modeling matrix NI and the parameter vector p. For example, determining the residuals may include calculating the norm of the difference between the data d and the modeling matrix M multiplied by the parameter vector p, according to a rearrangement of equation (1):

l(p,d)=∥d−Mp∥₂ (2)

where l(p, d) represents residual portions of the element of the collected data d, which remain after subtraction of the modeling matrix NI multiplied by the parameter vector p calculated in the solution space Sᵢ. The term l(p, d) may be referred to as the “data fitting term,” and a lower value thereof may represent a better data fit. As in equation (2), the data fitting term may be calculated as the norm of the difference between the element of the seismic data d and the modeling matrix NI multiplied by the parameter vector p.

The method 200 may also include adding a regularization term r(p) to the residuals term l(p, d) in order to stabilize the optimization problem or identify a unique solution wherein there are more than one solutions to optimizing l(p, d) alone. An example of the regularization term r(p) is ∥p∥₂. By adding the regularization term, a data fitting term may be generated as l(p, d)+r(p). Accordingly, in at least one embodiment, this may be the data fitting term used for selecting the parameter vector p in the solution space Sᵢ.

When a parameter vector p is selected in the solution space Si, e.g., based on the data fitting term, it may be labeled as a “candidate” parameter vector, and added to a list of candidate parameter vectors, as at 212. For the first solution space considered in the method 200, the list may begin as empty. Moreover, at the conclusion of the loop 207, the list may include one candidate parameter vector from one, some, or each of the solution spaces Sᵢ; for example, by using the regularization term r(p) to avoid non-unique solutions. In some embodiments, however the list of candidate parameter vectors may include two or more parameter vectors from one, some, or all of the solution spaces Sᵢ, and/or may not include candidate parameter vectors for one or more of the solution spaces Sᵢ.

The method 200 may proceed to determining whether there are additional solution spaces Sᵢ of the set S to consider, as at 214. If there are, the method 200 may return to block 208, restarting the loop 207, and may choose another solution space Sᵢ₊₁ to consider. Accordingly, the method 200 may include considering one, some, or all of the solution spaces Sᵢ of the set S, and may find a candidate parameter vector p for one, some, or all of the solution spaces Sᵢ of the set S considered.

The list of candidate parameter vectors p may thus be established. At this point, or any time beforehand in the method 200, the method 200 may include calculating a penalty term that favors lower complexity (e.g., as measured by the number of elements in the parameter vector, sparseness (as with a L₁ norm), entropy, etc.), as at 216. The penalty term may be associated, for example, with a user input or may be otherwise determined or predetermined as part of the method 200. The user input may generally be a multiplier, which may be related to a weight placed on the complexity. The penalty term may be represented by c(p) (or c(Sᵢ) since the penalty term may be a function of complexity, which may be determined based at least partially on the solution space Si of the candidate parameter vector p). It will be appreciated, however, that the penalty term may be a function of window location, or one of many other possibilities. Continuing with the illustrative example using c(p), the following equation may be developed:

l(p,d)+r(p)+c(p),p in Sᵢ,i=1 . . . N (3)

The method 200 may then proceed to selecting the candidate parameter vector based on a combination of the data fitting term and the penalty term, as at 218. The data fitting term (e.g., the combination of the residuals l(p, d) and the regularization term r(p)) may already have been calculated for one, some, or each of the candidate parameter vectors p, as this may be at least part of the basis upon which the candidate parameter vectors p were selected for the list of candidate parameter vectors from the solution spaces Sᵢ. Moreover, higher complexity candidate parameter vectors may, in some cases, tend to have more favorable data fitting terms, indicating less residuals. However, the penalty term may increase according to increasing complexity (although not necessarily proportionally or linearly), or otherwise favor lower complexity models. Thus, by considering (e.g., optimizing) equation (3), e.g., at 218, a candidate parameter vector p may be chosen from the list of candidate parameter vectors.

Embodiments of the method 200 may be tailored for a variety of uses, which may have one or more different solution spaces. For example, the method 100 may be employed in residual moveout correction or amplitude versus offset analysis, in either of these examples, embodiments can be formulated as a polynomial fitting problem, and embodiments of the method 100 can be used to find the order (complexity) of the polynomial. In such case, the modeling matrix M may be a matrix where elements are various orders of variables (e.g., time or offset index). The solution space set S may be a set of real spaces of different dimensions representing different polynomial orders, and the parameter vector p may be the polynomial coefficients. The method 200 may also be adapted for predictive deconvolution, source-signature deconvolution, and surface-consistent decomposition applications, among, other possibilities.

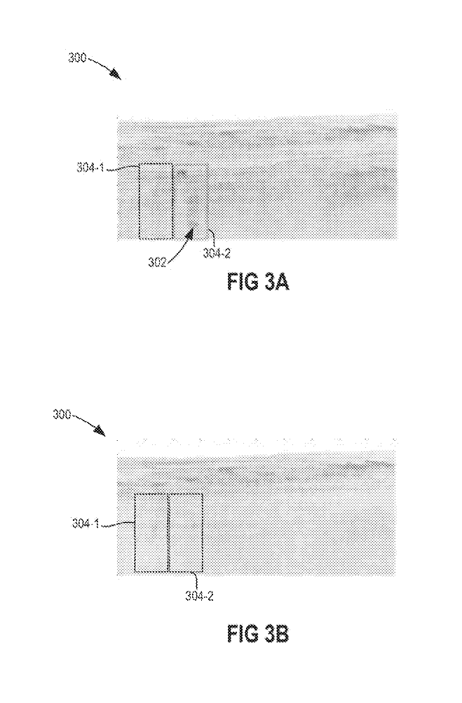

FIGS. 3A and 3B illustrate views of a domain 300 of seismic data, according to an embodiment. In at least one embodiment, time may be on the vertical axis, although this may be converted to distance or depth according to a variety of known processes. The horizontal axis may be related to location. The domain 300 may be or include seismic data that is acquired, e.g., a plurality of seismic traces. Further, the seismic data of the domain 300 may have a multiples reflection element 302.

Briefly, a seismic trace may include a signal representing primary reflections, e.g., where the seismic signal is reflected by an interface between two layers. Once received, e.g., by geophones, and processed, the primary reflections signal may provide insight into the structure, geology, etc., of the domain 300. Multiples reflections occur when a primary reflection, on its path hack to the geophones, is reflected downwards by a superpositioned interface. The multiples signal may thus travel downwards again, until it is once more reflected by an interface and travels upwards again. The multiples signal may be reflected downwards and upwards one or more additional times, as well. The multiples signal may thus not be indicative of the location of the interfaces, as the multiples signal may take longer in time to reach geophones. Accordingly, in some case, the multiples reflection signal or “element” miry be noise in the seismic trace of the domain 300. Adaptive subtraction processes may remove some or all of the multiples reflection element from the domain 300.

The seismic trace in the domain 300 may be partitioned into a plurality of sampling windows (two are shown for purposes of illustration: 304-1, 304-2), e.g., according to a set time interval. It will be appreciated that other sampling windows may be defined, e.g., according to location, calculated depth, etc. The sampling windows 304-1, 304-2 may, in some embodiments, be treated as generally discrete segments of information, which may be processed with varying levels of aggressiveness to remove the multiples reflection signals for “elements”) found therein, while preserving the integrity of the primary reflection signal. For example, in the window 304-2, where the multiples reflection element 302 is seen, the aggressiveness e.g., complexity) of the filter applied may be higher than in the window 304-1 where such a multiples reflection element is not seen. The result of such a filter being applied may be the domain 300 of FIG. 3B, where the multiples reflection element 302 is removed, or at least attenuated.

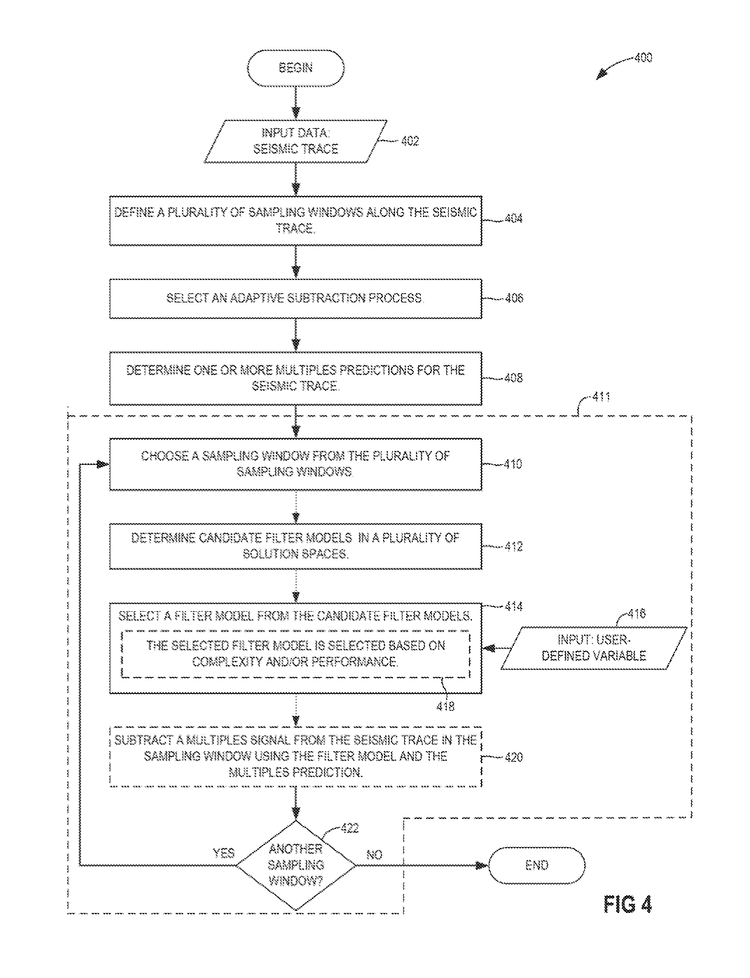

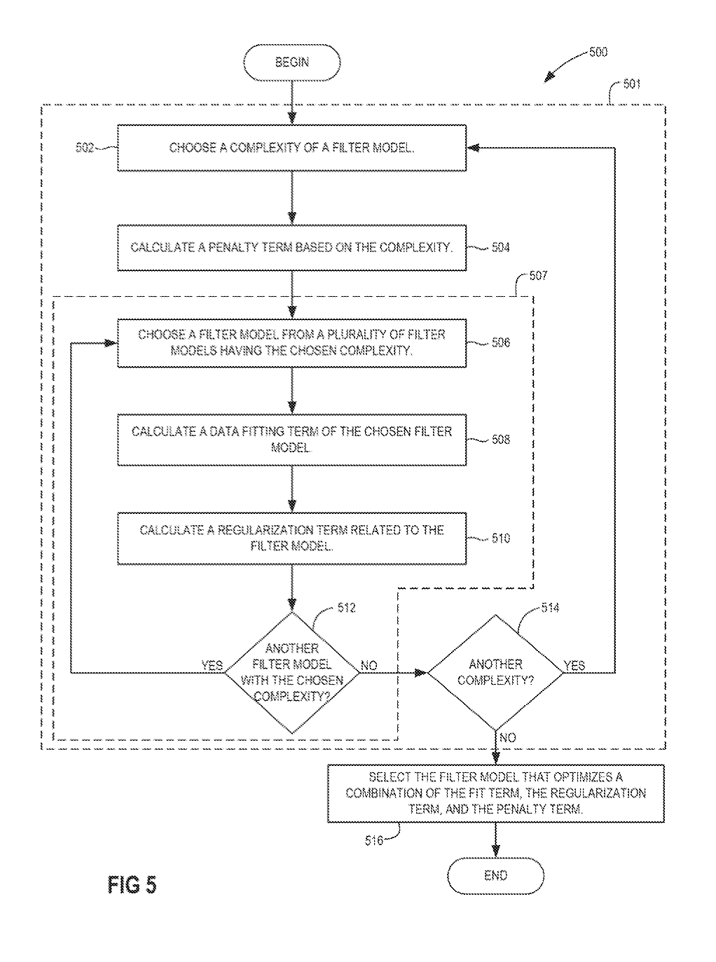

FIG. 4 illustrates a flowchart of a method 400 for removing a signal element from a seismic trace, according to an embodiment. The method 400 may begin by receiving seismic data, such as a seismic trace, as input, as at 402. The seismic trace may, in at least some embodiments, be a combination of several signals, which may be representative of reflections, noise, etc. For example, the seismic trace may be defined as follows:

x=p+u+m (4)

where xεR^{N} denotes the seismic trace, uεR′ models the additive noise, pεR^{N} and mεR^{N} represent the unknown primary and multiple reflections, respectively, and R^{N} denotes that the seismic trace elements x, p, and u have N number of real samples.

The method 400 may then partition, segment, or otherwise consider segments of the seismic trace, e.g., by defining a plurality of sampling windows along the seismic trace, as at 404. The sampling windows may be defined in terms of time, i.e., with a certain time duration of the seismic trace being contained in each of the sampling windows. In other embodiments, however, the sampling windows may be based on characteristics other than time, for example, location, frequency, etc.

The method 400 may further include selecting an adaptive subtraction process, as at 408. A variety of adaptive subtraction processes designed to remove multiples signals from seismic traces may be applied. Adaptive subtraction processes may include, for example, least squares adaptive subtraction, L₁-norm (L₁) adaptive subtraction, pattern matching-based subtraction, and higher-order statistics methods.

The method 400 may also include determining one or more multiples predictions \tilde{m} for the seismic trace, as at 406, which may be related to the multiples m in the seismic trace x. The multiples prediction \tilde{m} may also be referred to herein as a “signal” prediction, e.g., for the multiples signal of the seismic trace. The multiples prediction \tilde{m} may be predefined, provided as an input, calculated according to any suitable process, or a combination thereof. Further, the multiples predictions, \tilde{m} may be related to the unknown multiples m via a parametric model or “filter model” θ of K parameters, θ=[θ₁ . . . , θ_{K}]^{T}. A linear filtering model may be developed as:

m=\tilde{M}θ (5)

where \tilde{M}εR^{N}^{ₓ}^{K} is a Toeplitz matrix formed by time-shifted versions of \tilde{m}, and θ represents a (K−1)ₜₕ-order finite impulse response filter (FIR). Both the data for signal) x, and matrix \tilde{M} may represent seismic data in arbitrary domain and order; furthermore, the matrix \tilde{M} can be constructed to incorporate multi-dimensional spatial windowing.

The method 400 may then proceed to choosing a sampling window from the plurality of sampling windows, as at 410, e.g., as a loop control variable for iteration of loop 411. Accordingly, one, some, or all of the sampling windows may be considered in turn, as the loop 411 iterates. It will be appreciated that the loop 411 may proceed in any order with respect to the sampling windows and may, in some cases, be parallelized, with the operations in some or all loops 411 being distributed among a plurality of processors, threads, cores, etc.

Within the loop 411, the method 400 may include determining candidate filter models in a plurality of solution spaces, as at 412. For example, one candidate filter model may be selected in each solution space. In an embodiment, the candidate filter model may be selected in the solution space based on the performance of an adaptive subtraction process using the candidate filter model, relative to the performance of the adaptive subtraction process using other filter models of the solution space. Such performance may be established by a data fitting term, which may measure a difference between the seismic element and a combination of the modeling matrix and the parameter vectors. Accordingly, a plurality of candidate filter models (e.g., a list thereof) may be established.

The method 400 may include selecting among the candidate filter models, as at 414. In some embodiments, a variable, such as a user-defined variable, may be received as input, as at 416. The user-defined variable may set a weight that the candidate filter models are penalized, such that the selection at 414 tends to favor less complex candidate filter models. The selection at 414 may thus proceed by considering (e.g., optimizing) the combination of the performance of an adaptive subtraction process using the candidate filter models across the solution spaces, as well as optimizing for complexity of the candidate filter models.

In some embodiments, as at 418 in FIG. 4, the selected filter model is selected based on complexity. In some embodiments, the selected filter model is selected based on performance. In still other embodiments, the selected filter model is selected based on a combination of complexity and performance.

In another embodiment, the variable input at 416 may be related to a residuals tolerance. A test statistic for each of the candidate models selected for the solution spaces may be calculated. A residuals term may be calculated from the residuals tolerance, and may set a threshold, below which, the candidate filter model is considered to leave no multiples signal element when used in an adaptive subtraction process. The selecting at 414 may compare some, or all of the candidate filter models, e.g., in order of complexity, and may include selecting the least complex candidate filter model with a test statistic associated therewith that falls below the residuals term.

The process of selecting the candidate filter model may include applying the candidate filter model to the seismic trace in an adaptive subtraction process. For example, the performance of a candidate filter model may be determined by performing the adaptive subtraction process using the candidate filter model. In other embodiments, it may not. In at least one embodiment, either during (e.g., as part of or after selecting, at 414, the method 400 may include subtracting the multiples signal from the seismic trace in the sampling, window, using the selected filter model, as at 420. The multiples signal may be subtracted at 420 according to the adaptive subtraction process selected at 408, using the filter model selected at 414 in other cases, however, a plurality of adaptive subtraction processes may be considered, e.g., the adaptive subtraction process may be selected within the loop between 410 and 420.

The method 400 then includes determining whether additional sampling windows are available for applying adaptive subtraction thereto, as at 422. In some embodiments, the determination at 422 may be “YES” if one or more windows of the seismic trace have not yet been considered, and “NO” after all windows have been considered. In other embodiments, a subset of windows may be considered, and thus the determination may be a “YES” despite the existence of windows that have not been considered in the loop between 410 and 420.

If the determination is “YES,” the method 400 moves to the next iteration of the loop 411, e.g., by choosing another sampling window at 410 and proceeding towards 422, as described above. If the determination is “NO,” the method 400 ends.

FIG. 5 illustrates a method 500 for selecting a filter model, according to an embodiment. For example, the method 500 may be employed as, or as part of, determining the candidate filter models in the plurality of solution spaces, as at 412 (FIG. 4), of the method 400, and/or selecting the filter model from the candidate filter models, as at 414 (FIG. 4), of the method 400. The method 500 may include performing an outer loop 501, which may begin b choosing a complexity of a candidate filter model, as at 502. Choosing at 502 may be considered determining a first loop control variable, e.g. of the outer loop 501. As noted above with reference to FIG. 4, multiple solution spaces (complexities) of the filter models may be provided, and each solution space may have multiple possible filter models, from which a candidate, from the particular solution space, may be chosen.

The method 500 may proceed to calculating a penalty term based at least partially on the complexity, as at 504. Although shown being calculated within the iteration of the outer loop 501, it will be appreciated that the penalty term may be calculated beforehand, or after the running of the outer loop 501, or elsewhere in the method 500. The penalty term may be calculated based, for example, on a user input, but in other embodiments, may be recalculated, calculated (e.g., optimized) based on other data, etc.

The method 500 may proceed to choosing, a filter model from a plurality of filter models in the solution space (e.g., having the chosen complexity), as at 506. This may commence an inner loop 507, which may be based on the filter models within the solution space (complexity). Within the inner loop 507, the method 500 may include calculating a data fitting term of the chosen filter model, as at 508. The data fitting term may be calculated based on a linear relationship, e.g., such as the linear relationship defined in method 200 at 204.

Accordingly, the “solution spaces” may be levels of complexity for the parametric filter model (parameter vector) θ. In an embodiment, multiple parametric filter models θ_{α} may be considered, with the index α representing a solution space in the set of solution spaces A={α₁, α₂, . . . , α_{L}}, which may be indexed according to complexity. Thus, considering equations (4) and (5), across solution spaces A, yields:

x=Mθ_{α}+p+u,αεA (6)

In some embodiments, a candidate filter model θ_{α} may be selected for one, some, or each solution space (complexity) α. The candidate filter models θ_{α} may be selected based at least partially on a performance of an adaptive subtraction process using the filter model (e.g., the “data fitting term” mentioned above with respect to 508). The performance using the filter model θ_{α} may be determined at least partially from the norm of the difference between the multiples signal element m and the combination of the modeling matrix \tilde{M} and the filter model θ_{α}. In a specific embodiment, the performance may be expressed as ∥m−Mθ_{α}∥₂.

One or more of the filter models θ_{α} of the solution space may have a regularization term applied thereto, as described above with reference to method 200 (FIG. 2). An example of the regularization term r(θ_{α}) is |θ_{α}|₂.

The method 500 may conclude the inner loop 507 by determining whether there is another filter model in the solution space (e.g., having the complexity), as at 512. If one or more filter models θ_{α} remain for consideration, the method. 500 may restart the inner loop 507 by choosing another filter model θ_{α} in the solution space α at 506. This may continue until a data fitting term and a regularization term (where applied) are calculated for the filter models of the solution space. The inner loop 507 may thus provide, for the solution spaces considered, the data fitting term and (where provided) the regularization term, e.g., for the filter models θ_{α} considered in the solution space α. The filter models θ_{α} in the solution spaces α may be selected as “candidate” filter models, e.g., using the data fitting term and the regularization term, e.g., as at 412 in FIG. 4.

When the determination at 512 is “NO,” the method 500 concludes the outer loop 501 by determining whether another complexity (solution space) is available for consideration, as at 514. If there is (i.e., the determination is “YES”), the method 500 may return to the beginning of the outer loop 501 and may include choosing another complexity at 502. When the determination at 514 is “NO”, the outer loop may terminate.

Thus, in a specific embodiment, the data fitting terms and the regularization terms for each of the filter models in each of the solution spaces may be determined. The method 500 may then proceed to selecting the filter model (or “candidate” filter model) based on a combination of the data fining term, the regularization term, and the penalty term.

In a specific, embodiment, with the size (complexity) of the solution space a noted as d_{α}, the selected filter model θ_{α}* may be selected using a generalized information criterion (GIC) parameter selector, as follows:

$${α}^{*} , {\hat{θ}}_{α} = {arg min}_{{θ}_{α} ∈ {R}^{{d}_{α}} , α ∈ A} \{ \frac{1}{N} [ 𝓁 ( {θ}_{α} ) - N λ p ( {θ}_{α} ) + {κ}_{N} {d}_{α} ] \} \qquad ( 7 )$$

where κ_{N} is a positive number that may at least partially control or influence the weight given to the complexity of the candidate models when performing the selection. In an embodiment, the number κ_{N} may be received as an input, such as at 416 of method 400. Moreover, referring back to equation (3), equation (7) may be the linear equation developed, where p=θ_{α}, r(p)=Nλp(θ_{α},) and κ_{N}d_{α}=c(p) (or c(Sᵢ)). The joint optimization of Equation (7) over α*, \hat{θ}_{α} may be separable and thus may be expressed as:

$$\begin{matrix}{α}^{*} = {arg min}_{α ∈ A} \{ \frac{1}{N} [ G ( x , {\hat{θ}}_{α} ) + {κ}_{N} {d}_{α} ] \} & ( 8 ) \\ {\hat{θ}}_{α} = {arg min}_{{θ}_{α} ∈ {R}^{{d}_{α}}} {Q}_{λ} ( {θ}_{α} ) \\ where & ( 9 ) \\ {Q}_{λ} ( {θ}_{α} ) = 𝓁 ( {θ}_{α} ) - N λ p ( {θ}_{α} ) , & ( 10 )\end{matrix}$$

The selected candidate filter model θ_{α}* may be found through equation (9) with α* plugged in, where \hat{θ}_{α} is the model selected based on the data fitting term and (where provided) the regularization term fir the chosen solution spaces α. In Equation (8), G(x, \hat{θ}_{α}) measures the fitting of the model parameter \hat{θ}_{α} to x, and may, in some cases, be equal to Q_{λ}(θ_{α}). Equation (10) may represent anon-concave penalized likelihood function where l(θ_{α}) is the log-likelihood-based loss function of parameter θ_{α}, p(θ_{α}) is a penalty function, and λ is the regularization parameter. An example of the penalty function p(θ_{α}) may be the L_{q}-norm (0<q<2).

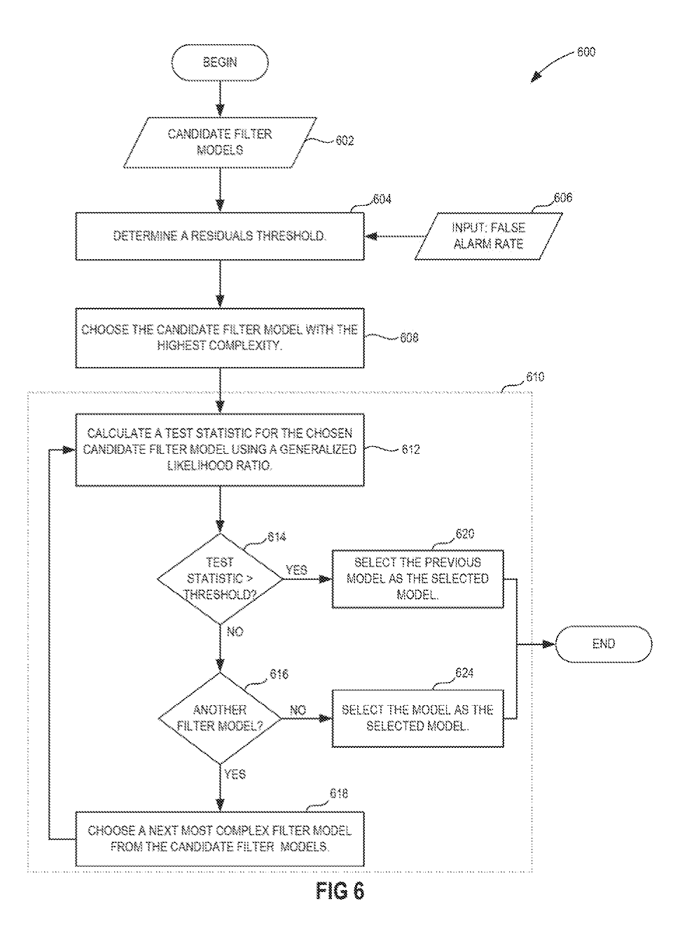

FIG. 6 illustrates a flowchart of another method 600 for selecting a filter model, according to an embodiment. For example, the method 600 may be employed as, or as part of determining the candidate filter models in the plurality of solution spaces, as at 412 (FIG. 4), of the method 400, and/or selecting the filter model from the candidate filter models, as at 414 (FIG. 4), of the method 400. In an embodiment, the method 600 may begin by receiving candidate filter models, e.g., one tot each solution space (complexity) being considered v at 602. The candidate filter models may be selected, as provided in method 400 at 412 (FIG. 4), or m any other suitable manner.

The method 600 may also include determining a residuals threshold, as at 604. The residuals threshold may, in some embodiments, be calculated based on a user input, which, in an embodiment, may be a false alarm rate, as at 606. In some embodiments, however, the false alarm rate may be computed or predetermined, or the residuals threshold may be calculated on the basis of any other suitable variable. Additional details regarding the residuals threshold are provided below.

The method 600 may then proceed to choosing a candidate filter model, as at 608. As shown, in an embodiment, the chosen candidate filter model may have a highest complexity among the candidate filter models being considered. In other embodiments, however, the first chosen candidate filter model may have a complexity that is not the highest of the group; for example, some complexities may be ruled out as too high, etc. In at least one embodiment, the candidate filter models may be, at least from a conceptual standpoint, arranged in order of decreasing complexity, and thus the first chosen may be the most complex. In other cases, however, the candidate filter models may be arranged in other ways, or randomly, and a search may be performed to find the candidate filter model of a certain complexity, e.g., in this case, the most complex.

The method 500 may then begin a loop 610, which may begin by calculating a test statistic for the chosen candidate filter, e.g., using a generalized likelihood ratio, as at 612. For example, testing may include application of a statistical model. In some cases, the primary reflections signal p and the additive noise signal u are normally distributed with zero mean and covariance σ²I, where the variance r may not be known. The generalized likelihood ratio (GLRT) principle may then be used to construct the test statistic Tᵢ, where i=1, . . . , L:

$${T}_{i} = \frac{N - P}{P} \frac{{( {\hat{x}}_{{α}_{( i )}}^{AS} )}^{T} {{\tilde{M}}^{′} ( {{\tilde{M}}^{′}}^{T} {\tilde{M}}^{′} )}^{- 1} {\tilde{M}}^{′ T} {\hat{x}}_{{α}_{( i )}}^{AS}}{{( {\hat{x}}_{{α}_{( i )}}^{AS} )}^{T} ( I - {{\tilde{M}}^{′} ( {{\tilde{M}}^{′}}^{T} {\tilde{M}}^{′} )}^{- 1} {\tilde{M}}^{′ T} ) {\hat{x}}_{{α}_{( i )}}^{AS}} \qquad ( 11 )$$

This test statistic Tᵢ may then be compared against the aforementioned residuals threshold, as at 614. If the test statistic Tᵢ is below the threshold (i.e., the determination at 614 is “NO”), it may be concluded that the candidate filter model being tested removes the multiples signal from the seismic trace (or portion thereof) to which the adaptive subtraction process is applied. This may mean that the complexity of the candidate filter model is sufficiently high, but the candidate filter model may not necessarily be the least complex filter model that is considered to remove the multiple signal. In that case, the method 600 may determine whether there are other, e.g., less complex, candidate filter models to consider, as at 616. If there are (i.e., the determination at 616 is “YES”), the method 600 may select the next-most complex filter model, as at 616, and restart the loop 610 by returning to 612.

If the determination at 614 is “YES,” then it may be concluded that the complexity of the candidate filter model being considered is too low; that is, the candidate filter model, when applied to the adaptive subtraction process, leaves a multiples signal (in excess of the residual threshold) in the seismic trace. In this case, it may be concluded that the candidate filter model is not complex enough. Since the iterations of the loop 610 progressively consider lower complexities, the first time the complexity is too low, the method 100 may select the previous (i.e., next-higher complexity) candidate filter model, as at 612, which may end the loop 610 and the method 600.

On the other hand, if selecting the previous model at 620 is not reached, despite there being no additional candidate filter models to consider (e.g., the determination at 616 is “NO”), the conclusion may be that the seismic trace, or portion thereof, is free from multiples signals. Thus, the least complex candidate model (e.g., the last candidate filter model considered in the loop 610) may be selected, as at 624.

This workflow may be referred to as a “multiple hypothesis test.” In particular, such a multiple hypothesis test may be considered as a binary determination for each candidate filter model, specifically:

For i=1, . . . , L, perform the following binary hypothesis test:

Hᵢ: \hat{x}_{α}_{₍ᵢ₎}^{AS} does not contain multiple reflections, represented as \hat{x}_{α}_{₍ᵢ₎}^{AS}=p+u (12a)

Aᵢ: \hat{x}_{α}_{₍ᵢ₎}^{AS} contain multiple reflections, represented as \hat{x}_{α}_{₍ᵢ₎}^{AS}=\tilde{M}′β+p+u (12b)

where \tilde{M}′εR^{N}^{ₓ}^{P} is a Toeplitz matrix formed by time-shifted versions of \tilde{m} and βεR^{P} denote an unknown but nonzero set of parameters. The similarity between (12b) and (6) may allow reusing the linear filtering model of equation (5) to represent the hypothesis Aᵢ where the multiple-attenuated data (seismic trace) \hat{x}_{α}_{₍ᵢ₎}^{AS} still contains residual multiples. Among these L hypothesis tests, r of them, {i₁, i₂, . . . , iᵣ}ε{1, . . . , L}, may be rejected, namely Hᵢ₁, . . . , Hᵢᵣ, then the index for the simplest model, i* is determined by

i*=max{i₁,i₂, . . . ,iᵣ}+1. (13)

if none of the L hypotheses are rejected, the seismic trace x may be considered to be multiple-free.

This application of the generalized information criterion may, in at least one embodiment, have a generally constant false alarm rate, e.g., a determination that an adaptive subtraction process employing the chosen candidate parameter vector has residuals above a tolerance, when it does not. The residuals threshold γ can thus be determined by setting the false alarm rate a. As noted above with respect to 606, the false alarm rate a may be taken as an input from the user, or determined in any other way. Accordingly, the performance of the multiple hypothesis tests (combined performance of all L tests) can be performed using a family-wise error rate criterion, leading to the following expression for the threshold, γ:

$$γ = \frac{{Q}_{{F}_{P , N - P}}^{- 1} ( a )}{L} \qquad ( 14 )$$

where F_{P,N-P} denotes an F distribution with P numerator degree of freedom and N-P denominator degree of freedom, Q is the tail probability of the F_{P,N-P} distribution, and its inverse, Q⁻¹, can be found by table lookup. Other multiple hypothesis test procedures may also be developed, based on the false discovery rate or other variables.

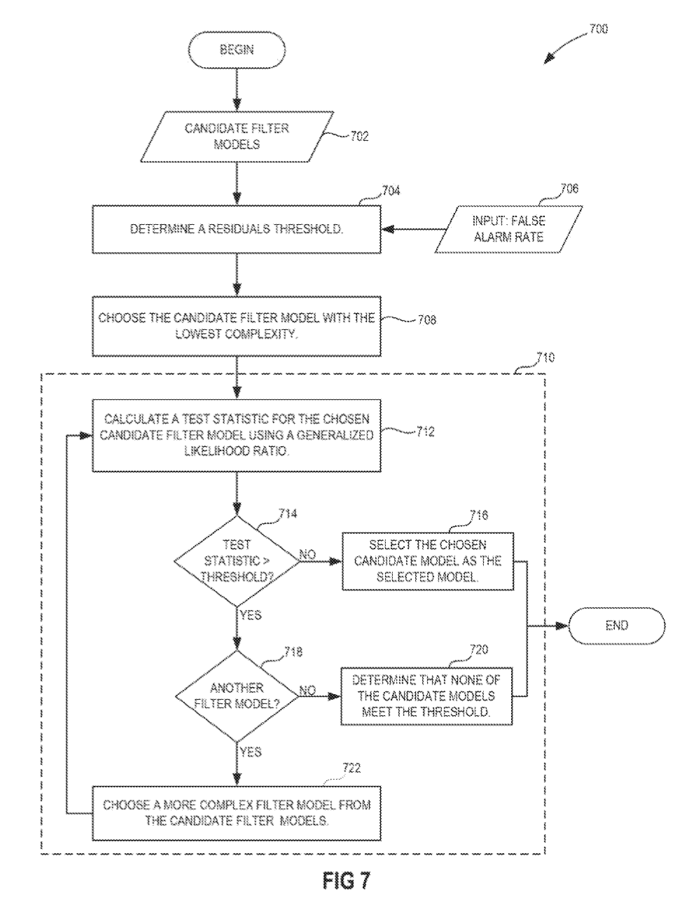

FIG. 7 illustrates a flowchart of another method 700 for selecting a filter model, according to an embodiment. The method 700 may provide an embodiment of selecting the filter model at 414 of method 400 (FIG. 4). Further, the method 700 may proceed as a multiple-hypothesis test, similar to method 600, described above. The method 700 may thus begin by receiving the candidate filter models (e.g., a list thereof) for each of the solution spaces (complexities), as at 702. The method 700 may also include determining a residuals threshold, as at 704, which may be calculated based on a false alarm rate that is received, e.g. from a user, as at 706. The threshold may be determined as discussed above with reference to 604.

In an embodiment, the candidate filter models may be arranged, at least conceptually, in order of increasing complexity. The method 700 may include initially choosing the least complex filter model, as at 708, thereby beginning a loop 710. In other embodiments, the initially chosen filter model may have a complexity that is higher than the least-complex filter model of the candidate filter models. In the loop 710, the method 700 may include calculating a test statistic for the chosen candidate filter model, e.g., using a generalized likelihood ratio, as at 712. The test statistic may be calculated at 712 similar to the manner in which the test statistic Tᵢ as described above with reference to 612 FIG. 6).

The method 700 may also include determining whether the test statistic is greater than the threshold, as at 714. If the test statistic for the chosen candidate filter model the determination is “YES” at 714), it may be concluded that the chosen candidate filter model is insufficiently complex to remove the multiples signal from the seismic trace. Accordingly, the method 700 may proceed to determining whether another (e.g., more complex) filter model is available for consideration, as at 718. If one or more additional candidate filter models are available for consideration (i.e., the determination at 718 is “YES”), the method 700 may include choosing a more complex filter model from the candidate filter models. For example, the next least complex candidate filter model may be selected at 722, and the loop 710 may be restarted.

If, however, the test statistic is below the threshold (i.e., the determination at 714 is “NO”), the chosen candidate filter model being of sufficient complexity. Accordingly, the method 700 may proceed to selecting the chosen candidate filter model as the selected filter model, as at 716. Since the candidate filter models are chosen for consideration in the loop 710 in order of increasing complexity, subsequent filter models may be assumed to yield a test statistic that is below the threshold; however, they may have a higher complexity than the first candidate filter model chosen that yields a test statistic below the threshold. Accordingly, if lower complexity is favored, in an example embodiment, the first candidate filter model that yields a test statistic below the threshold may be the selected filter model, and the loop 710 and method 700 may end.

If, however, the end of the candidate filter models for consideration is reached the determination at 718 is “NO”) without selecting a filter model, it may be determined that none of the candidate filter models yield a test statistic that meets the threshold, as at 720. In such case, a variety of corrective measures may be taken such as, for example, changing the false alarm and/or threshold.

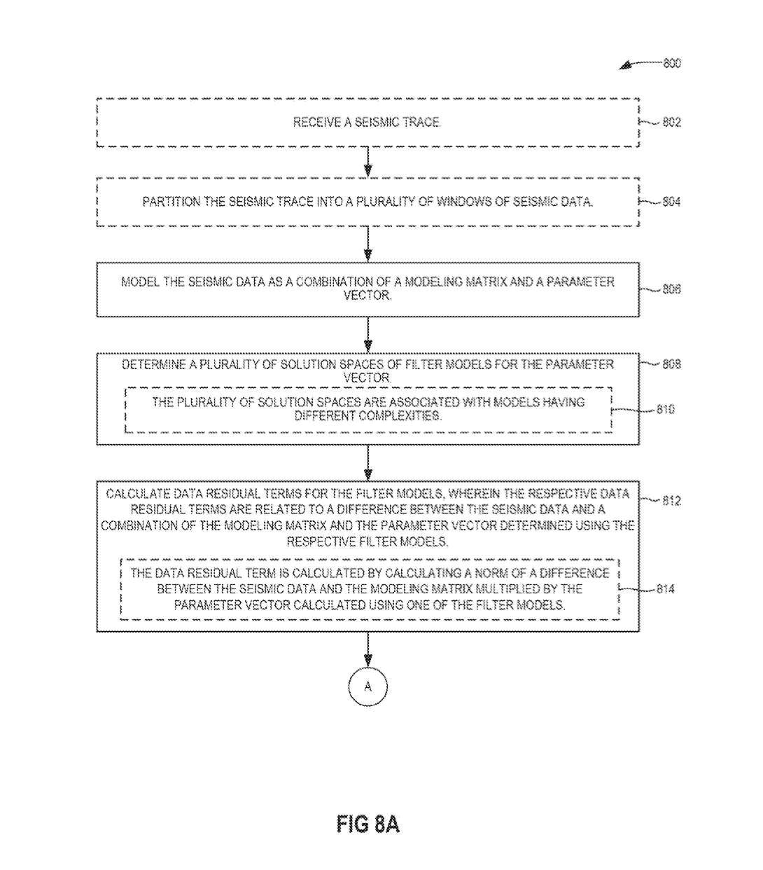

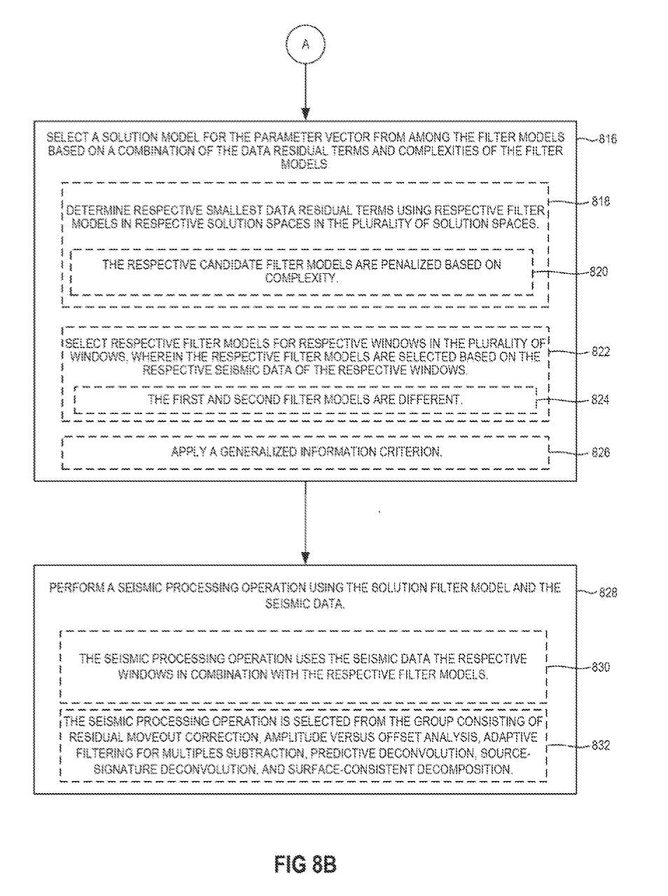

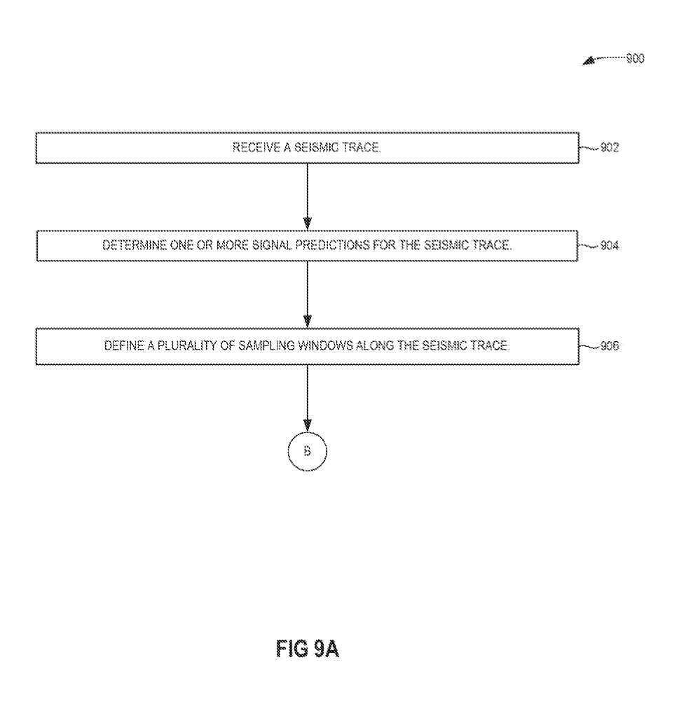

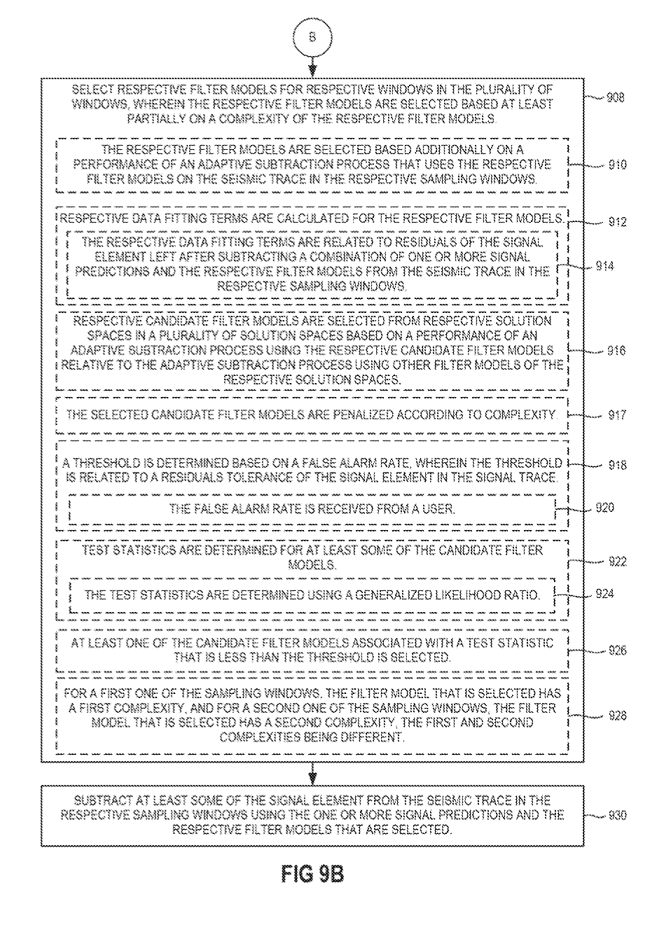

Attention is now directed to FIGS. 8A and 8B FIGS. 9A and 9B, which are flow diagrams illustrating, methods 800 and 900, respectively, for processing collected data in accordance with some embodiments. Some operations in methods 800 and/or 900 may be combined and/or the order of some operations may be changed. Further, some operations in methods 800 and/or 900 may be combined with aspects of the example workflows of FIGS. 1, 2, and 4-7, and/or the order of some operations in methods 800 and/or 900 may be changed to account for incorporation of aspects of the workflow illustrated by one or more of FIGS. 1, 2, and 4-7.

Referring now specifically to FIGS. 8A and 8B, there is illustrated a flowchart of a method 800 for processing seismic data, according, to an embodiment. The method 800 may include receiving a seismic trace, as at 802 (e.g., FIG. 2, 202, receiving seismic data input). In an embodiment, the method 800 may also include partitioning the seismic trace into a plurality of windows of seismic data, as at 804 (e.g., FIG. 4, 404, defining a plurality of sampling windows along the seismic trace). It will be appreciated, however, that embodiments that omit blocks 802 and 804 are specifically contemplated herein.

The method 800 may also include modeling the seismic data as a combination of a modeling matrix and a parameter vector, as at 806 (e.g., FIG. 2, 204, defining a linear relationship between an element of the seismic data and a combination of a modeling, matrix and a parameter vector).

The method 800 may also include determining a plurality of solution spaces of filter models for the parameter vector, as at 808 (e.g., FIG. 2, 206, determining a plurality of solution spaces for the parameter vector). In an embodiment, the plurality of solution spaces may be associated with filter models having, different complexities, as indicated at 810 (e.g., FIG. 5, the outer loop 501 may iterate through two or more complexities chosen at 502).

The method 800 may also include calculating data residual terms for the filter models, as at 812 (e.g., FIG. 2, 506, calculating a data fitting term of the chosen filter model). The respective data residual terms may, in an embodiment, be related to a difference between the seismic data and a combination of the modeling matrix and the parameter vectors calculated using the respective filter models. In a specific embodiment, the data residual term may be calculated by calculating a norm of a difference between the seismic data and the modeling matrix multiplied by the parameter vector calculated using one of the candidate filter models, as at 814.

The method 800 may also include selecting a solution filter model for the parameter vector from among the filter models based on a combination of the data residual terms and complexities of the filter models, as at 816 (e.g., FIG. 2, 218, selecting the candidate parameter vector based on a combination of the data fitting term and the penalty term). In an embodiment, this may include determining the smallest data residual terms using the respective filter models in respective solution spaces in the plurality of solution spaces, as at 818. Further, the candidate filter models may be penalized based on complexity, as at 820 (e.g., FIG. 2, 216, calculating a penalty term that favors lower complexity).

In an embodiment, selecting the solution filter model at 818 may include selecting respective filter models for respective windows in the plurality of windows, wherein the respective filter models are selected based on the respective seismic data of the respective windows, as at 822 (e.g., FIG. 4, 420, subtracting a multiples signal from the seismic trace in the sampling window using the filter model. In addition, the loop 411 may iterate through two or more the different sampling windows). In such an embodiment, the first and second filter models may be different, as at 824.

in an embodiment, selecting the solution at 818 may include applying a generalized information criterion, as at 826.

The method 800 may also include performing a seismic processing operation using the solution filter model and the seismic data, as at 828 (e.g., FIG. 1, 108, performing a seismic operation using the selected solution for the parameter vector). For example, performing the seismic processing operation may include using the seismic data of the respective windows (of the plurality of windows) in combination with the respective filter models, as at 830 (e.g., FIG. 4, 420, subtracting a multiples signal from the seismic trace in the sampling window using the filter model). Further, performing the seismic processing operation may include performing an operation selected from the group including residual moveout correction, amplitude versus offset analysis, adaptive filtering for multiples subtraction, predictive deconvolution, source-signature deconvolution, and surface-consistent decomposition, as at 832.

FIGS. 9A and 9B illustrate a flowchart of a method 900 for processing seismic data, according to an embodiment. The method 900 may include receiving a seismic trace, as at 902 (e.g., FIG. 4, 402, receiving input seismic trace). The method 900 may also include determining one or more signal predictions for the seismic trace, as at 904 (e.g., FIG. 4, 408, determine one or more multiples predictions for the seismic trace). The method 900 may also include defining a plurality of sampling windows along the seismic trace, as at 906 (e.g., FIG. 4, 404, a plurality of sampling, windows along the seismic trace).

The method 900 may further include selecting respective filter models for respective windows in the plurality of windows, wherein the respective filter models are selected based at least partially on a complexity of the respective filter models, as at 908 (e.g., FIG. 4, 414, selecting a filter model from the candidate filter models; e.g., FIG. 4, 418, the selected filter model is selected based on complexity and/or performance). In an embodiment, the respective filter models are selected based additionally on a performance of one or more adaptive subtraction processes that use the respective filter models on the seismic trace in the respective sampling windows, as at 910 (e.g., FIG. 4, 420, the process of selecting the candidate filter model (414) may include applying, the candidate filter model to the seismic trace in an adaptive subtraction process; thus, the method 400 may include subtracting the multiples signal from the seismic trace in the sampling window, using the selected filter model, as at 420).

In an embodiment, respective data fitting terms are calculated for the respective filter models, as at 912 (e.g., FIG. 5, 508, calculating a data fitting term of the chosen filter model). In an embodiment, the respective data fitting terms are related to residuals of the signal element left after subtracting a combination of one or more modeling matrices and the respective filter models from the seismic trace in the respective sampling windows, as at 914 (e.g., FIG. 4, 414, selecting a filter model from the candidate filter models based (418) on complexity and/or performance. Performance may, in an embodiment, be determined by (420) subtracting a multiples signal from the seismic trace in the sampling window using the filter model).

In an embodiment, respective candidate filter models are selected, from respective solution spaces in a plurality of solution spaces based on a performance of an adaptive subtraction process using the respective candidate filter models relative to the performance of the adaptive subtraction process using other filter models of the respective solution spaces, as at 916. In an embodiment, the respective filter models are penalized according to complexity, as at 917 (e.g., FIG. 2, 216, calculating a penalty term that favors lower complexity).

In an embodiment, a threshold is determined based on a false alarm rate, wherein the threshold is related to a residuals tolerance of the signal element in the seismic trace, as at 918 (e.g., FIG. 6, 604, determining a residuals threshold). In an embodiment, the false alarm rate is received from a user, as at 920 (e.g., FIG. 6, 606, receiving the input false alarm rate).

In an embodiment, test statistics may be determined for at least some of the candidate filter models, as at 922 (e.g., FIG. 6, 612, calculating a test statistic for the chosen candidate filter model). In an embodiment, the test statistics are determined using a generalized likelihood ratio, as at 924 (e.g., FIG. 6, 612, the test statistic is calculated using a generalized likelihood ratio). In an embodiment, at least one of the candidate filter models associated with a test statistic that is less than the threshold is selected, as at 926 (e.g., FIG. 6, 614, if the test statistic is less than the threshold, the method 600 may proceed to determining if there is another (lower complexity) filter model, at 616. If there is not, the method 600 may include selecting the filter model as the selected model at 624).

In an embodiment, for a first one of the sampling windows, the filter model that is selected has a first complexity, and for a second one of the sampling windows, the filter model that is selected has a second complexity, the first and second complexities being different, as at 928 (e.g., FIG. 4, the loop 411 may iterate through two or more sampling windows, and the models selected at 414 may have different complexities).

The method 900 may also include subtracting at least some of the signal element from the seismic trace in the respective sampling windows using the one or more signal predictions and the respective filter models that are selected, as at 930 (e.g., FIG. 4, 420, subtracting a multiples signal from the seismic trace in the sampling window using the filter model and the multiples prediction).

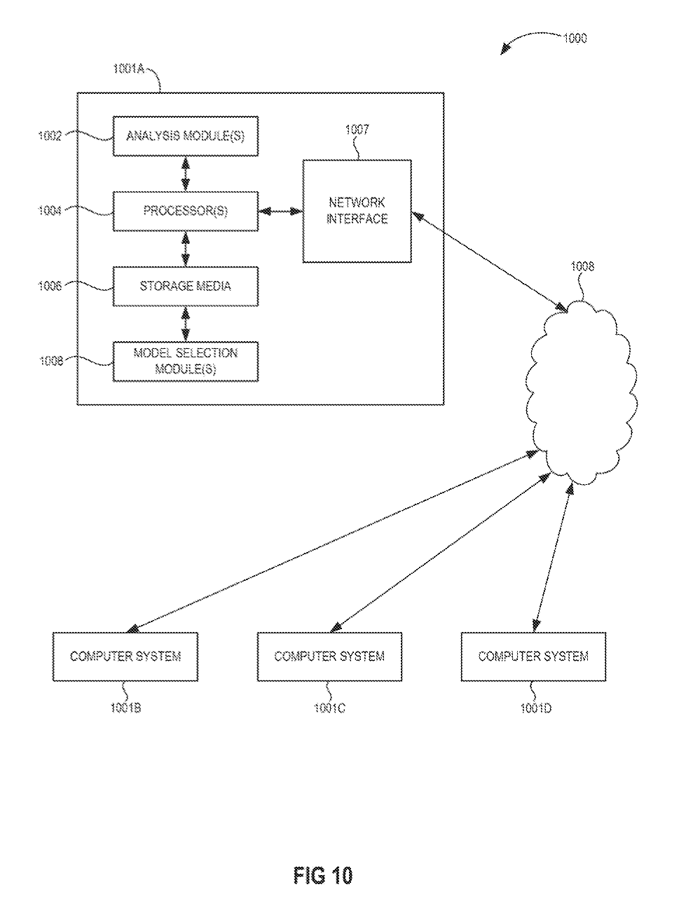

In some embodiments, the methods 100, 200, 400, 500, 600, 700, 800, and/or 900 may be run on a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis modules 1002 that are configured to perform various tasks according to some embodiments, such as one or more methods disclosed herein (e.g., methods 100, 200, 400, 500, 600, 700, 800, and/or 900, and/or combinations and/or variations thereof). To perform these various tasks, the analysis module 1002 executes independently, or in coordination with, one or more processors 1004, which is (or are) connected to one or more storage media 1006A. The processor(s) 1004 is for are) also connected to a network interface 1007 to allow the computer system 1001A to communicate over a data network 1008 with one or more additional computer systems and/or computing systems, such as 1001B, 1001C, and/or 1001D) (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor can include a microprocessor, microcontroller, processor module or subsystem, programmable integrated circuit, programmable gate array, or another control or computing device.

The storage media 1006A can be implemented as one or more computer-readable or machine-readable storage media. Note that while in the example embodiment of FIG. 10 storage media 1006A is depicted as within computer system 1001A, in some embodiments, storage media 1006A may be distributed within and/or across multiple internal and/or external enclosures of computing system 1001A and/or additional computing, systems. Storage media 1006A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs). BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more model selection module(s) 1008. In the example of computing system 1000, computer system 1001A includes model selection module 1008. In some embodiments, a single model selection module may be used to perform some or all aspects of one or more embodiments of the methods 100 and/or 300-900. In alternate embodiments, a plurality of model selection modules may be used to perform some or all aspects of methods 100 and/or 300-900.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein ma be implemented by running one or more functional modules in information processing apparatus such as general purpose processors or application specific chips, such as ASICs. FPGAs, PLDs, or other appropriate devices. These modules, combinations of these modules, and/or their combination with general hardware are all included within the scope of protection of the invention.

The steps in the processing methods described herein may be implemented by running one or more functional modules in information processing apparatus such as general purpose processors or application specific chips, such as ASICs, FPGAs. PLDs, or other appropriate devices. These modules, combinations of these modules, and/or their combination with general hardware are all included within the scope of protection of the invention.

It is important to recognize that geologic interpretations, models and/or other interpretation aids may be refined in an iterative fashion; this concept is applicable to methods 100, 200, 400, 500, 600, 700, 800, and 900 as discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to hunt the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for seismic processing, comprising:
modeling seismic data as a combination of a modeling matrix and a parameter vector;
determining a plurality of solution spaces of filter models for the parameter vector;
calculating data residual terms for the filter models, wherein the respective data residual terms are related to a difference between the seismic data and a combination of the modeling matrix and the parameter vector calculated using the respective filter models;
selecting a solution filter model for the parameter vector from among the filter models based on a combination of the data residual terms and complexities of the filter models; and
performing a seismic processing operation using the parameter vector calculated using the solution filter model and the seismic data.

2. The method of claim 1, wherein the plurality of solution spaces are associated with a plurality of different complexities of the filter models.

3. The method of claim 1, wherein selecting the solution filter model comprises:
determining respective smallest data residual terms using respective filter models in respective solution spaces in the plurality of solution spaces; and
penalizing the filter models based on complexity.

4. The method of claim 1, wherein selecting the solution filter model comprises applying a generalized information criterion.

5. The method of claim 1, wherein calculating, the data residual terms comprises calculating a norm of a difference between the seismic data and the modeling matrix multiplied by the parameter vector calculated using one of the filter models.

6. The method of claim 1, further comprising:
receiving a seismic trace; and
partitioning the seismic trace into a plurality of windows of seismic data,
wherein selecting the solution filter model for the parameter vector comprises selecting respective filter models for respective windows in the plurality of windows, wherein the respective filter models are selected based on the respective seismic data of the respective windows.

7. The method of claim 6, wherein performing the seismic processing operation comprises performing the seismic processing operation using the seismic data of respective windows in combination with the respective filter models.

8. The method of claim 1, wherein performing the seismic processing operation comprises performing an operation selected from the group consisting of residual moveout correction, amplitude versus offset analysis, adaptive filtering for multiples subtraction, predictive deconvolution, source-signature deconvolution, and surface-consistent decomposition.

9. A method for removing a signal element from a seismic trace, comprising:
receiving the seismic trace;
determining one or more signal predictions for the seismic trace;
defining a plurality of sampling windows along the seismic trace;
selecting respective filter models for respective windows in the plurality of sampling windows based at least partially on a complexity of the respective filter models, and
subtracting at least some of the signal element from the seismic trace in the respective sampling windows using, the one or more signal predictions and the respective filter models that are selected.

10. The method of claim 9, wherein selecting the respective filter models comprises selecting the respective filter models based additionally on a performance of an adaptive subtraction process that uses the respective fitter models on the seismic trace in the respective sampling windows.

11. The method of claim 9; wherein selecting the respective filter models comprises calculating respective data fitting terms for the respective filter models, wherein the respective data fitting terms are related to residuals of the signal element left after subtracting a combination of the one or more signal predictions and the respective filter model from the seismic trace in the respective sampling windows.

12. The method of claim 9, wherein selecting the respective filter models comprises:
selecting respective candidate filter models from respective solution spaces in a plurality of solution spaces based on a performance of an adaptive subtraction process using the respective candidate filter models relative to the performance of the adaptive subtraction process using other filter models of the respective solution spaces; and
penalizing the selected candidate filter models based on a complexity of the selected candidate filter models.

13. The method of claim 9, wherein selecting the respective filter models comprises:
selecting respective candidate filter models from respective solution spaces in plurality of solution spaces based on a performance of an adaptive subtraction process using, the respective candidate filter models relative to the performance of the adaptive subtraction process using other filter models of the respective solution spaces;
determining a threshold based on a false alarm rate, wherein the threshold is related to a residuals tolerance of the signal element in the seismic trace;
determining test statistics for at least some of the candidate filter models; and
selecting at least one of the candidate filter models associated with a test statistic that is less than the threshold.

14. The method of claim 13, further comprising receiving the false alarm rate from a user.

15. The method of claim 13, wherein determining the test statistics comprises using a generalized likelihood ratio.

16. The method of claim 9, wherein, for a first one of the sampling windows, the filter model that is selected has a first complexity, and for a second one of the sampling, windows, the filter model that is selected has a second complexity, the first and second complexities being different.

17. A computing system, comprising:
one or more processors; and
a memory system comprising one or more computer-readable media storing instructions thereon that, when executed by the one or more processors, are configured to cause the computing system to perform operations, the operations comprising:
modeling seismic data as a combination of a modeling matrix and a parameter vector;
determining, a plurality of solution spaces of filter models for the parameter vector;
calculating data residual terms for the fitter models, wherein the respective data residual terms are related to a difference between the seismic data and a combination of the modeling matrix and the parameter vector calculated using the respective filter models;
selecting a solution filter model for the parameter vector from among the filter models based on a combination of the data residual terms and complexities of the filter models; and
performing a seismic processing operation using the parameter vector calculated using the solution filter model and the seismic data.

18. The system of claim 17, wherein selecting the solution filter model comprises:
selecting respective candidate filter models associated with respective solution spaces in the plurality of solution spaces, wherein the respective candidate filter models have a smallest data residual term relative to data residual terms of the filter models of the respective solution spaces; and
penalizing the respective candidate filter models based on the complexity of the respective candidate filter models.

19. The system of claim 17, wherein calculating the data residual terms comprises calculating a norm of a difference between the seismic data and the modeling matrix multiplied by the parameter vector calculated using one of the filter models.

20. The system of claim 17, wherein the operations further comprise:
receiving a seismic trace; and
partitioning the seismic trace into a plurality of windows of seismic data,
wherein selecting the solution filter model for the parameter vector comprises selecting respective filter models for respective windows in the plurality of windows, wherein the respective filter models are based on the respective seismic data of the respective windows.
